(19) United States
(12) Patent Application Publication
(10) Pub. No.: US 2019/0393827 A1
(43) Pub. Date: Dec. 26, 2019

(54) PORTABLE, SOLAR ENERGY SYSTEMS FORMED FROM PLURALITY OF SOLAR ENERGY COMPONENTS

(71) Applicant: Solarflexes LLC, Milford, CT (US)

(72) Inventor: David Michael Lutian, Milford, CT (US)

(21) Appl. No.: 16/447,285

(22) Filed: Jun. 20, 2019

Related U.S. Application Data
(60) Provisional application No. 62/687,523, filed on Jun. 20, 2018.

(51) Int. Cl. H02S 20/30; H02S 30/20; F24S 23/70; F24S 30/455

(52) U.S. Cl. CPC H02S 20/30; H02S 30/20; F24S 2023/85; F24S 30/455; F24S 2023/878; F24S 23/70

(57) ABSTRACT

Portable, solar energy systems formed from a plurality of solar energy components are disclosed. The solar energy components of the portable, solar energy systems may include photovoltaic (PV) components or heliostat components. The portable, solar energy systems may include a plurality of either PV assemblies or heliostat assemblies. Each of the assemblies may include a support structures and a plurality of PV components coupled thereon, or a plurality of heliostat components. The support structures of the assemblies may be coupled one another to allow the plurality of assemblies forming the portable, solar energy system to be unfolded from a storage container.

### CROSS-REFERENCE TO RELATED APPLICATIONS

This application claims the benefit of U.S. Provisional Application Ser. No. 62/687,523, filed Jun. 20, 2018, which is hereby incorporated by reference herein.

### BACKGROUND OF THE INVENTION

The disclosure relates generally to portable, solar energy systems, and more particularly, to portable, solar energy systems formed from a plurality of photovoltaic (PV) components or portable, solar energy systems formed from a plurality of heliostat components.

Conventional solar energy systems or fields typically require extensive preparation and/or installation. Specifically, preparation of the land in which the solar energy field will be installed on is often extensive and expensive. For example, once the site for the solar energy system has been chosen, the land must often be cleared, leveled or graded, and built-up (e.g., access roads to the site) before actual solar energy components may even begin to be installed. This process can take upwards of 9 to 12 months and cost more than one million dollars ($1,000,000 USD).

Furthermore, and dependent on size of the solar energy field, the preparation and/or installation of the solar energy components utilized within the solar energy field can also be time consuming and expensive. For example, each solar energy component, whether it be a photovoltaic (PV) component or a heliostat component, must be installed individually on-site. As such, the installation of all the solar energy components can take between 12 and 24 months. Additionally, the installation of the solar energy components that make up a solar energy field can cost well over ten million dollars ($10,000,000 USD). As a result, conventional solar fields may take between 18 to 36 months before becoming operational, and cost tens of millions of dollars to create a single solar energy field.

### BRIEF DESCRIPTION OF THE INVENTION

A first aspect of the disclosure provides a solar energy system including: a plurality of portable photovoltaic (PV) assemblies coupled together, each of the plurality of PV assemblies including: a support structure including: a base frame including: a first end; a second end positioned opposite the first end; a first side extending between the first end and the second end; a second side extending between the first end and the second end, the second side positioned opposite the first side; and at least one stiffener extend between the first side and the second side; a first plurality of supports positioned adjacent the first side of the base frame, each of the first plurality of supports including: a first end pivotably coupled to the base frame; and a second end positioned opposite the first end; and a second plurality of supports positioned adjacent the second side of the base frame, each of the second plurality of supports including: a first end pivotably coupled to the base frame; and a second end positioned opposite the first end; a first plurality of photovoltaic (PV) components pivotably coupled to the second end of the first plurality of supports; and a second plurality of PV components pivotably coupled to the second end of the second plurality of supports.

A second aspect of the disclosure provides a solar energy system including: a plurality of portable heliostat assemblies coupled together, each of the plurality of heliostat assemblies including: a support structure including: a first end; a second end positioned opposite the first end; a first side extending between the first end and the second end; and a second side extending between the first end and the second end, the second side positioned opposite the first side; and a plurality of heliostat components extending between the first end and the second end of the support structure, each of the plurality of heliostat components including: a base; a plurality of connector extending from the base, each connector for connecting the base to one of a first end of the support structure, a second end of the support structure, or a distinct base of a distinct; a post extending from the base; and a mirror pivotably coupled to the post.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows an isometric view of a portable photovoltaic (PV) assembly of a solar energy system in an operational state, according to embodiments.

FIG. 2 shows a front view of the portable PV assembly of FIG. 2 in the operational state, according to embodiments.

FIG. 3 shows a side view of the portable PV assembly of FIG. 2 in the operational state, according to embodiments.

FIG. 4 shows an isometric view of the portable PV assembly of the solar energy system of FIG. 1 in a partially-collapsed state, according to embodiments.

FIG. 5 shows a front view of the portable PV assembly of FIG. 4 in the partially-collapsed state, according to embodiments.

FIG. 6 shows a top view of the portable PV assembly of FIG. 4 in the partially-collapsed state, according to embodiments.

FIG. 7 shows a side view of the portable PV assembly of FIG. 4 in the partially-collapsed state, according to embodiments.

FIG. 8 shows an isometric view of the portable PV assembly of the solar energy system of FIG. 1 in a collapsed state, according to embodiments.

FIG. 9 shows a top view of the portable PV assembly of FIG. 8 in the collapsed state, according to embodiments.

FIG. 10 shows a bottom view of the portable PV assembly of FIG. 8 in the collapsed state, according to embodiments.

FIG. 11 shows a front view of the portable PV assembly of FIG. 8 in the collapsed state, according to embodiments.

FIG. 12 shows an isometric view of a solar energy system including a plurality of portable PV assemblies in a collapsed state and positioned in a storage container, according to embodiments.

FIG. 13 shows an isometric view of the solar energy system of FIG. 12 including the plurality of portable PV assemblies in an operational state, according to embodiments.

FIG. 14 shows a side view of a plurality of portable PV assemblies of a solar energy system in a collapsed state and coupled to one another, according to embodiments.

FIG. 15 shows a side view of the plurality of portable PV assemblies of FIG. 14 in a collapsed state and partially expanded, according to embodiments.

FIG. 16 shows a side view of the plurality of portable PV assemblies of FIG. 14 in a collapsed state and fully expanded, according to embodiments.

FIGS. 17 and 18 show front isometric views of a portable heliostat assembly of a solar energy system in an operational state, according to embodiments.

FIG. 19 shows a side view of the portable heliostat assembly of FIGS. 17 and 18, according to embodiments.

FIG. 20 shows a back isometric view of the portable heliostat assembly of FIGS. 17 and 18, according to embodiments.

FIG. 21 shows an isometric view of a solar energy system including a plurality of portable heliostat assemblies in an operational state, according to embodiments.

FIG. 22 shows a side view of the solar energy system of claim 21, according to embodiments.

FIG. 23 shows an isometric view of a portion of the solar energy system of claim 21, according to embodiments.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within the portable, solar energy systems. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As indicated above, the disclosure relates generally to portable, solar energy systems, and more particularly, to portable, solar energy systems formed from a plurality of photovoltaic (PV) components or portable, solar energy systems formed from a plurality of heliostat components.

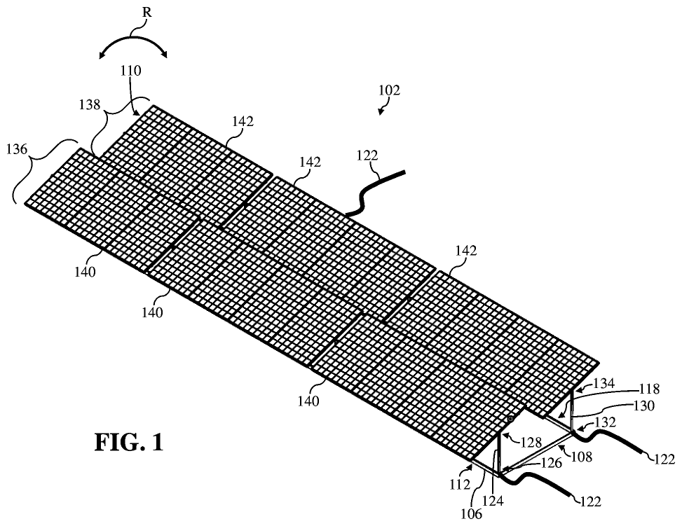

These and other embodiments are discussed below with reference to FIGS. 1-23. However, those skilled in the art will readily appreciate that the detailed description given herein with respect to these Figures is for explanatory purposes only and should not be construed as limiting.

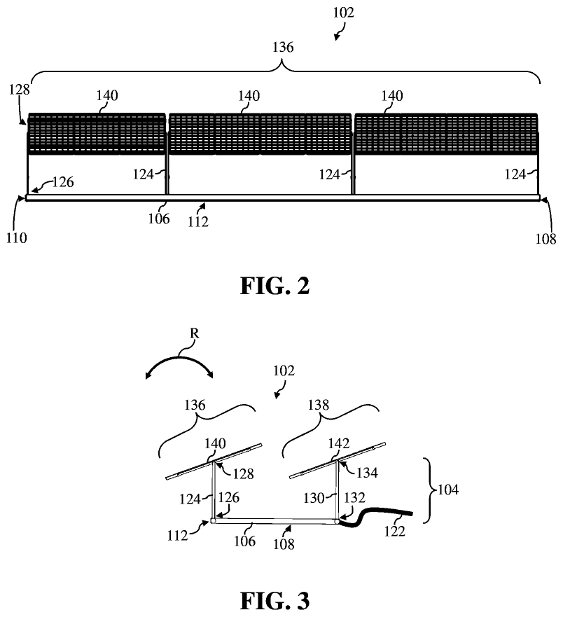

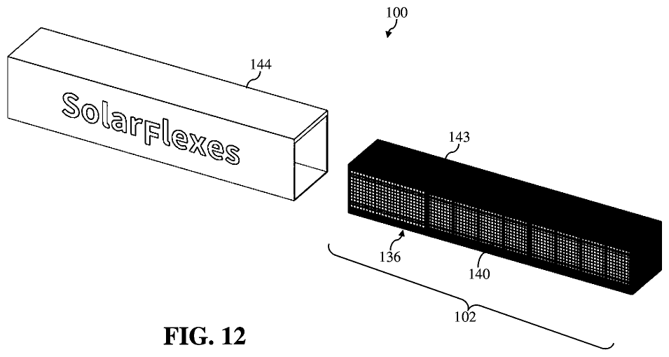

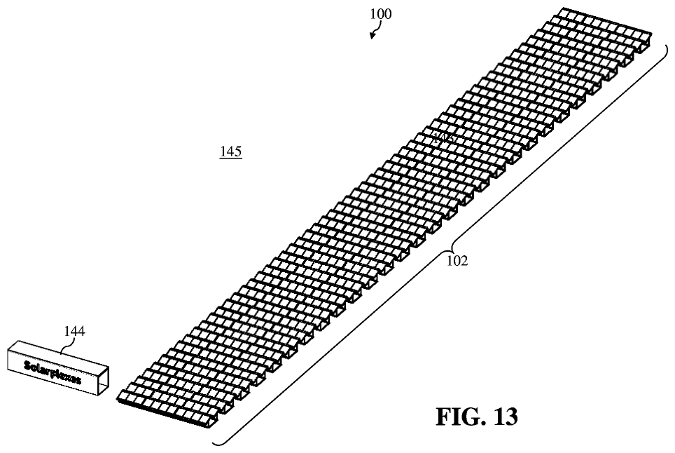

FIGS. 1-3 show various views of assemblies forming a solar energy system 100 (see, FIGS. 12 and 13) according to embodiments of the disclosure. More specifically, FIG. 1 shows an isometric view of a portable photovoltaic (PV) assembly 102 in an operational state, FIG. 2 shows a front view of portable PV assembly 102 in the operational state, and FIG. 3 shows a side view of portable PV assembly 102 in the operational state. As discussed herein, one or more portable PV assemblies 102 may be coupled together, and/or in electronic communication with one another to form solar energy system 100 (see, FIGS. 12 and 13). Additionally, and as discussed herein, a plurality of portable PV assembly 102 may be coupled together in an accordion-type style to form solar energy system 100, and may be unfolded from a storage container to be rapidly installed.

As shown in FIGS. 1-3, portable PV assembly 102 may include a support structure 104. Support structure 104 may support and/or house a plurality of components of portable PV assembly 102. In the non-limiting example, support structure 104 may include a base frame 106 formed from I-beams of, e.g., steel, or other metal segments joined, coupled, or welded together. However, it is understood base frame 106 may be formed as any component or structure that may support the various components of portable PV assembly 102, and allow solar energy system 100 to be rapidly installed, as discussed herein.

In the non-limiting example shown in FIGS. 1-3, base frame 106 formed from the plurality of joined (metal) segments may include a plurality of end segments and side segments. For example, base frame 106 may include a first end 108, and a second end 110 positioned opposite first end 108. Additionally, base frame 106 may also include a first side 112 extending between first end 108 and second end 110, and a second side 118 extending between first end 108 and second end 110. Second side 118 may also extend and/or may be positioned opposite first side 112. As shown in FIGS. 1-3, the various ends 108, 110, and sides 112, 118 may be configured such that base frame 106 of support structure 104 is substantially quadrilateral (e.g., rectangular).

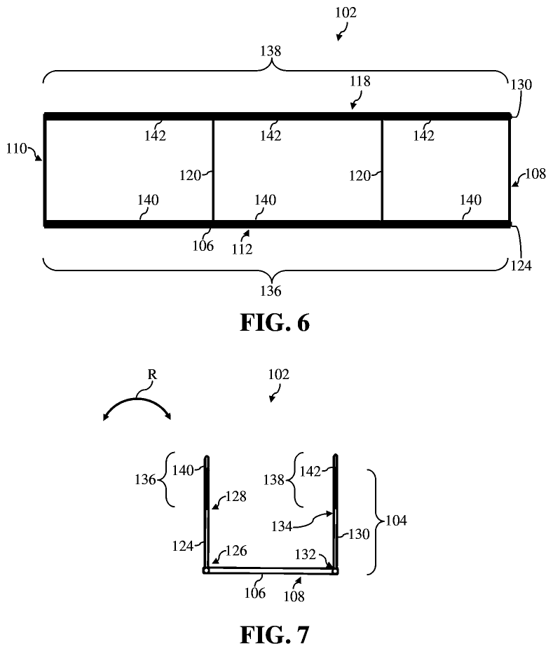

In addition, base frame 106 of support structure 104 may also include at least one stiffener 120 (see, FIG. 6). Stiffener(s) 120 may extend between and/or be coupled to first side 112 and second side 118 of base frame 106. Stiffener(s) 120 may also be positioned between and extend substantially parallel to first end 108, and second end 110, respectively. Stiffener(s) 120 may provide additional support and/or rigidity to base frame 106. Additionally, and as discussed herein, stiffener(s) 120 may provide a segment/portion of base frame 106 to allow additional components to be coupled thereon. The number of stiffener(s) 120 may be dependent, at least in part, on the size of base frame 106 and/or support structure 104. In the non-limiting example, base frame 106 may include two stiffeners 120 (see, FIG. 6).

In a non-limiting example, the joined metal segments forming base frame 106, and its various components (e.g., first end 108, second end 110, first side 112, second side 118, stiffener(s) 120), may be formed as a substantially hollow segment or part. At least a portion of the hollow segments or parts forming base frame 106 may be configured to receive the wiring 122 of other portions or components of portable PV assembly 102.

Support structure 104 of portable PV assembly 102 may also include a first plurality of supports 124. In the non-limiting examples shown in FIGS. 1-3, the first plurality of supports 124 may be positioned adjacent first side 112 of base frame 106. That is, the first plurality of supports 124 may be positioned adjacent to and/or be dispersed along first side 112 of base frame 106 of support structure 104. Similar to stiffener(s) 120, the number of supports included within the plurality of supports 124 may be dependent, at least in part, on the size of base frame 106 and/or support structure 104, and/or the number of photovoltaic components included within portable PV assembly 102.

Each of the supports of the plurality of supports 124 may include a first end 126. First end 126 may be pivotably coupled to base frame 106. More specifically, first end 126 of each first support 124 may be pivotably coupled to one of first end 108, second end 110, or stiffener 120. As a result of being pivotably coupled to base frame 106, each support of the first plurality of supports 124 may be configured to rotate in a direction (R) about first end 126. As discussed herein, support's 124 ability to rotate in a direction (R) about first end 126 may allow portable PV assembly 102 to be collapsed, stored, and/or rapidly installed. Additionally, each of the supports of the plurality of supports 124 may include a second end 128. Second end 128 may be positioned opposite first end 126 of supports 124. As discussed herein, second end 128 of supports 124 may be configured to receive and/or may be coupled to photovoltaic components of portable PV assembly 102 for solar energy system 100.

Support structure 104 of portable PV assembly 102 may also include a second plurality of supports 130, distinct from the first plurality of supports 124. In the non-limiting examples shown in FIGS. 1-3, the second plurality of supports 130 may be positioned adjacent second side 118 of base frame 106. That is, the second plurality of supports 130 may be positioned adjacent to and/or be dispersed along second side 118 of base frame 106 of support structure 104. Additionally, the second plurality of supports 130 may be positioned opposite the first plurality of supports 124 positioned adjacent first side 112. Similar to stiffener(s) 120, the number of supports included within the second plurality of supports 130 may be dependent, at least in part, on the size of base frame 106 and/or support structure 104, and/or the number of photovoltaic components included within portable PV assembly 102.

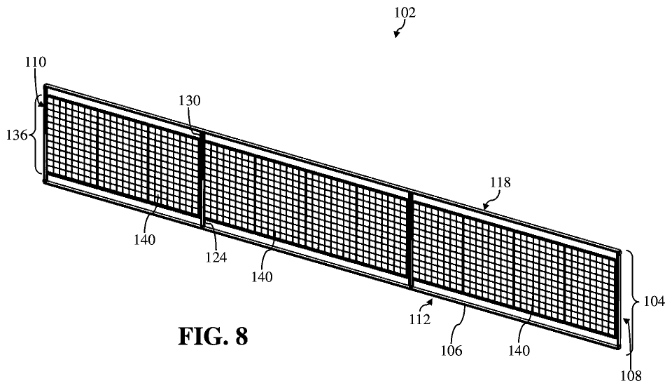

Similar to the first plurality of supports 124, each of the supports of the second plurality of supports 130 may include a first end 132 and a second end 134. First end 132 may be pivotably coupled to base frame 106. More specifically, first end 132 of each second supports 130 may be pivotably coupled to one of first end 108, second end 110, or stiffener 120. Additionally, first end 132 of second supports 130 may be coupled to base frame 106 at a different height than first end 126 of first supports 124. That is, first end 132 of second supports 130 may be coupled to base frame 106 at a height or position in a z-direction that is substantially lower than the height in which first end 126 of first supports 124 are coupled to base frame 106. As discussed herein, this may allow for first supports 124 and second supports 130 to be collapsed without contacting and/or interfering with one another when portable PV assembly 102 is in a collapsed state (see, FIGS. 8-11). As a result of being pivotably coupled to base frame 106, each support of the second plurality of supports 130 may be configured to rotate in a direction (R) about first end 132. As discussed herein, support's 130 ability to rotate in a direction (R) about first end 132 may allow portable PV assembly 102 to be collapsed, stored, and/or rapidly installed. Additionally, each of the supports of the second plurality of supports 130 may include second end 134. Second end 134 may be positioned opposite first end 132 of supports 130. As discussed herein, second end 134 of supports 130 may be configured to receive and/or may be coupled to photovoltaic components of portable PV assembly 102 for solar energy system 100.

As shown in FIGS. 1-3, portable PV assembly 102 of solar energy system 100 may include a first plurality of photovoltaic (PV) components 136. The first plurality of PV components 136 may be pivotably coupled to second ends 128 of the first plurality of supports 124. More specifically, each of the first plurality of PV components 136 may be pivotably coupled to corresponding second ends 128 of the first plurality of supports 124 of support structure 104. As a result of being pivotably coupled to second ends 128 of supports 124, the first plurality of PV components 136 may be configured to rotate in a direction (R) about second end 128. During operation, the first plurality of PV components 136 may be configured to rotate in a direction (R) about second end 128 to increase the generation of solar power/energy for solar energy system 100. Additionally, and as discussed herein, the ability for the first plurality of PV components 136 to rotate in a direction (R) about second end 128 may aid in the storage and/or rapid installation of portable PV assemblies 102 of solar energy system 100.

Portable PV assembly 102 of solar energy system 100 may also include a second plurality of photovoltaic (PV) components 138. The second plurality of PV components 138 may be pivotably coupled to second ends 134 of the second plurality of supports 130. More specifically, each of the second plurality of PV components 138 may be pivotably coupled to corresponding second ends 134 of the second plurality of supports 130 of support structure 104. As a result of being pivotably coupled to second ends 134 of supports 130, the second plurality of PV components 138 may be configured to rotate in a direction (R) about second end 134. During operation, the second plurality of PV components 138 may be configured to rotate in a direction (R) about second end 134 to increase the generation of solar power/energy for solar energy system 100. Additionally, and as discussed herein, the ability for the second plurality of PV components 138 to rotate in a direction (R) about second end 134 may aid in the storage and/or rapid installation of portable PV assemblies 102 of solar energy system 100.

The first plurality of PV components 136 and the second plurality of PV components 138 of portable PV assembly 102 may be formed as a collection of solar cells 140, 142 configured to generate energy via solar power. More specifically, the first plurality of PV components 136 may include a first collection of solar cells 140, and the second plurality of PV components 138 may include a second collection of solar cells 142. The number of solar cells 140, 142 included within first plurality of PV components 136 and second plurality of PV components 138 may be dependent, at least in part, on the size of base frame 106. That is, although each of first plurality of PV components 136 and second plurality of PV components 138 are shown to include seven distinct collections of solar cells 140, 142, the first plurality of PV components 136 and second plurality of PV components 138 may include more or less collections of solar cells.

Wiring 122 received and/or disposed through hollow portions or segments of base frame 106 of portable PV assembly 102 may be in electrical communication with solar cells 140, 142 of the first plurality of PV components 136 and second plurality of PV components 138. Wiring 122 may transfer and/or translate the energy generated by solar cells 140, 142 to additional components of solar energy system 100 (not shown) that may store and/or utilize the solar energy. Additionally, or alternatively, wiring 122 of portable PV assembly 102 may be electrically coupled and/or in electronic communication with at least one distinct, adjacent portable PV assembly 102 of solar energy system 100.

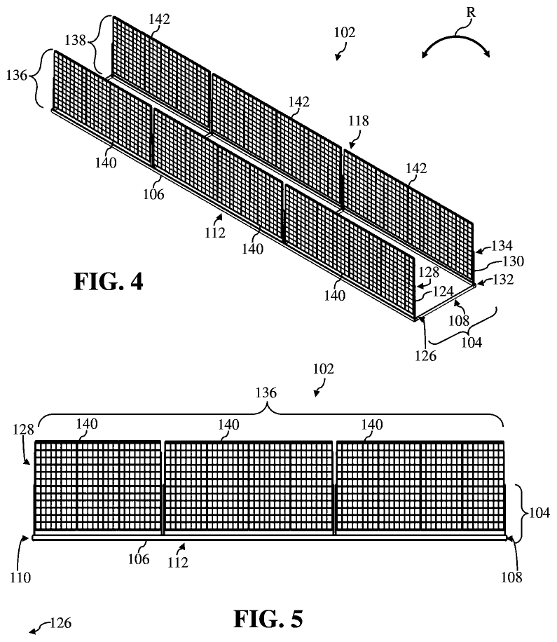

Turning to FIGS. 4-7, various views of portable PV assembly 102 of solar energy system 100 in a partially-collapsed state may be shown. Specifically, FIG. 4 shows an isometric view of portable PV assembly 102 in a partially-collapsed state, FIG. 5 shows a front view of portable PV assembly 102 in a partially-collapsed state, FIG. 6 shows a top view of portable PV assembly 102 in a partially-collapsed state, and FIG. 7 shows a side view of portable PV assembly 102 in a partially-collapsed state. It is understood that similarly numbered and/or named components may function in a substantially similar fashion. Redundant explanation of these components has been omitted for clarity.

In the non-limiting example shown in FIGS. 4-7, portable PV assembly 102 of solar energy system 100 may be in an intermediate and/or partially-collapsed state. Specifically, the first collection of solar cells 140 forming the first plurality of PV components 136 may be rotated in a direction (R) about second end 126 of the first plurality of supports 124 for support structure 104. The first collection of solar cells 140 forming the first plurality of PV components 136 may be rotated to, for example, a storage position such that the first collection of solar cells 140 may be positioned substantially upright and/or substantially parallel to the first plurality of supports 124 of support structure 104. Additionally in the storage position, the first collection of solar cells 140 forming the first plurality of PV components 136 may be positioned and/or oriented to face away from first supports 124 and/or base frame 106 of portable PV assembly 102.

Additionally, and similar to the first collection of solar cells 140 forming the first plurality of PV components 136, the second collection of solar cells 142 forming the second plurality of PV components 138 may be rotated in a direction (R) about second end 134 of the second plurality of supports 130 for support structure 104. The second collection of solar cells 142 forming the second plurality of PV components 138 may be rotated to, for example, a storage position such that the second collection of solar cells 142 may be positioned substantially upright and/or substantially parallel to the second plurality of supports 130 of support structure 104. Additionally in the storage position, the second collection of solar cells 142 forming the second plurality of PV components 138 may be positioned and/or oriented to face away from second supports 130 and/or toward first plurality of PV components 136.

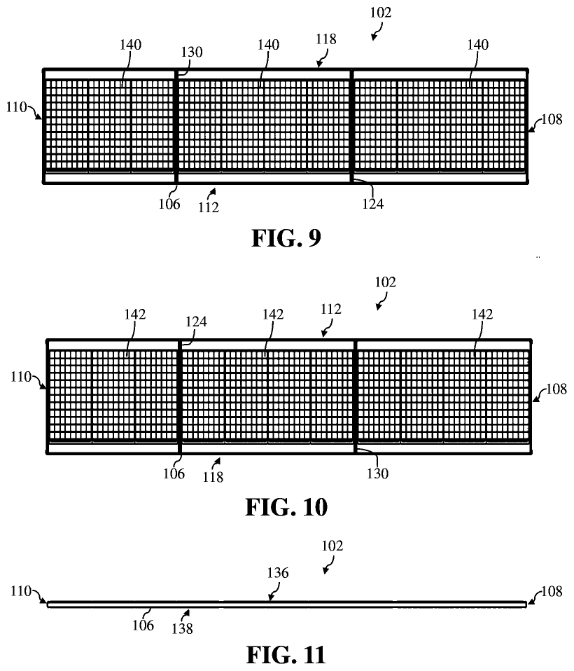

FIGS. 8-11 show various views of portable PV assembly 102 of solar energy system 100 in a collapsed state may be shown. Specifically, FIG. 8 shows an isometric view of portable PV assembly 102 in a collapsed state, FIG. 9 shows a top view of portable PV assembly 102 in the collapsed state, FIG. 10 shows a bottom view of portable PV assembly 102 in the collapsed state, and FIG. 11 shows a front view of portable PV assembly 102 in the collapsed state. It is understood that similarly numbered and/or named components may function in a substantially similar fashion. Redundant explanation of these components has been omitted for clarity.

In the non-limiting example shown in FIGS. 8-11, portable PV assembly 102 of solar energy system 100 may be in a collapsed state. Specifically, the first plurality of PV components 136 and the second plurality of PV components 138 may be positioned in a collapsed state to aid in storing and rapidly installing portable PV assembly 102 of solar energy system 100. In order for portable PV assembly 102 to be collapsed and/or positioned in the collapsed state, the first plurality of PV components 136 and the second plurality of PV components 138 may be folded, rotated, and/or positioned in the collapsed state. The order in which the first plurality of PV components 136 and the second plurality of PV components 138 may be folded, rotated, and/or positioned in the collapsed state may be dependent on a variety of features and/or characteristics of portable PV assembly 102 including, but not limited to, the size of each of solar cells 140, 142 for the first plurality of PV components 136 and the second plurality of PV components 138, the position of the first plurality of PV components 136 and the second plurality of PV components 138 on support frame 104, and the like.

For example, because first end 132 of second supports 130 may be coupled to base frame 106 at a height or position that is substantially lower than the height in which first end 126 of first supports 124 are coupled to base frame 106, the second plurality of PV components 138 may be folded, rotated, and/or positioned in the collapsed state prior to the first plurality of PV components 136 being positioned in the collapsed state. That is, the second plurality of supports 130, along with the second plurality of PV components 138, may be rotated in a direction (R) about first end 132 of second supports 130 toward base frame 106 and/or the first plurality of PV components 136, before rotating first plurality of PV component 138. Briefly turning to FIG. 10, solar cells 142 of the second plurality of PV components 138 may face downward and/or through base frame 106 when folded, rotated, and/or positioned in the collapsed state. This may be a result of the second collection of solar cells 142 of the second plurality of PV components 138 being positioned and/or oriented to face away from second supports 130 and/or toward the first plurality of PV components 136 in the partially-collapsed positioned (see, FIG. 4).

Once the second plurality of PV components 138 are folded, rotated, and/or positioned in the collapsed state, the first plurality of PV components 136 may be folded, rotated, and/or positioned in the collapsed state. Continuing the example, the first plurality of supports 124, along with the first plurality of PV components 136, may be rotated in a direction (R) about first end 126 of first supports 124 toward base frame 106 and/or the collapsed, second plurality of PV components 138. Once folded, rotated, and/or positioned in the collapsed state, the first collection of solar cells 140 of the first plurality of PV components 136 may face upward and/or away from base frame 106 (see, FIGS. 8 and 9) and second plurality of PV components 138. That is, when in the collapsed position, the first plurality of PV components 136 and second plurality of PV components 138 may face outward and/or away from one another. This may be a result of the first collection of solar cells 140 of the first plurality of PV components 136 being positioned and/or oriented to face away from first supports 124 and/or support structure 104 in the partially-collapsed positioned (see, FIG. 4).

Additionally, when in the collapsed state, the first plurality of PV components 136 and second plurality of PV components 138 may not contact one another. Specifically, and because first end 132 of second supports 130 may be coupled to base frame 106 at a height or position that is substantially lower than the height in which first end 126 of first supports 124 are coupled to base frame 106, the first plurality of PV components 136 may not contact, interfere with, rest on, and/or may be spaced apart from the second plurality of PV components 138. This may ensure that during transportation the first plurality of PV components 136 and/or second plurality of PV components 138 may not become damaged. Additionally, and as shown in FIG. 11, when the first plurality of PV components 136 and second plurality of PV components 138 are in the collapsed state, the first plurality of PV components 136 and second plurality of PV components 138 may be substantially contained within and/or positioned flush with base frame 106 of support structure 104. That is, the solar cells 140, 142 of the first plurality of PV components 136 and second plurality of PV components 138 may not extend beyond and/or above the various ends 108, 110 and sides 112, 118 of base frame 106, and may form a substantially planar surface for portable PV assembly 102 in the collapsed state. This may aid in and/or improve the storage and/or installation of portable PV assembly 102 for solar energy system 100.

FIG. 12 show solar energy system 100 formed a plurality of portable PV assemblies 102. Specifically, FIG. 12 shows solar energy system 100 including the plurality of portable PV assemblies 102 in a collapsed state and stored in a storage container 143. Storage container 143 may be configured to receive a plurality of portable PV assemblies 102 in the collapsed state. The portable PV assemblies 102 of solar energy 100 may all be positioned and/or oriented in the same direction when positioned or stored within storage container 143, as shown in FIG. 12. Storage container 143, and portable PV assemblies 102 forming solar energy system 100 stored within storage container 143, may also be configured to be received by trailer 144. Trailer 144 may be configured as any suitable trailer that may be towed or pulled by a tractor trailer or other transport truck. By sizing storage container 143, and portable PV assemblies 102 stored within storage container 143, to fit within trailer 144, solar energy system 100 including the plurality of portable PV assemblies 102 may be more easily transported to a solar energy field 145. Additionally, and in a non-limiting example, sizing storage container 143, and portable PV assemblies 102 stored within storage container 143, to fit within trailer 144 may allow an entire solar energy system 100 to be transported in a single shipment.

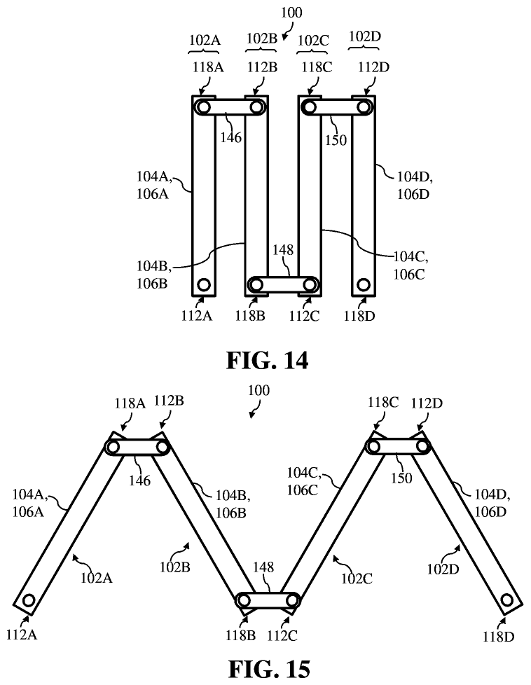

FIG. 13 shows solar energy system 100 installed in a solar energy field 145 after being removed from storage container 143. Specifically, FIG. 13 shows a non-limiting example of solar energy system 100 installed in solar energy field 145 after each of the plurality of portable PV assemblies 102 are removed from the storage container 143, and set-up or unfolded to an operational state (see, FIGS. 1-3). Each of the plurality of portable PV assemblies 102 may be unfolded to the operational state in a substantially similar, but reverse order, than that discussed herein with respect to FIGS. 1-11. Additionally, and as discussed herein with respect to FIG. 1, each of the plurality of portable PV assemblies 102 forming solar energy system 100 may be electrically coupled and/or in electronic communication with one another via wiring 122. As discussed herein, each of the plurality of portable PV assemblies 102 forming solar energy system 100 may also be (pivotably) coupled together to aid in the rapid-installation (see, FIGS. 14-16).

FIGS. 14-16 show various views of a plurality of portable PV assemblies 102 of solar energy system 100 coupled together. Specifically, FIGS. 14-16 show various views of support structures 104 and/or base frames 106 of a plurality of portable PV assemblies 102 coupled to one another and undergoing an unfolding and/or installation process. It is understood that similarly numbered and/or named components may function in a substantially similar fashion. Redundant explanation of these components has been omitted for clarity.

As shown in FIGS. 14-16 a plurality of portable PV assemblies 102A, 102B, 102C, 102D may form solar energy system 100. Each of the plurality of plurality of portable PV assemblies 102A, 102B, 102C, 102D may be substantially similar to portable PV assembly 102 discussed herein with respect to FIGS. 1-11. As such, each of the plurality of portable PV assemblies 102A, 102B, 102C, 102D may include substantially similar components and/or features including, but not limited to, support structures 104A, 104B, 104C, 104D and/or base frames 106A, 106B, 106C, 106D. In the non-limiting example shown in FIGS. 14-16, each of the plurality of portable PV assemblies 102A, 102B, 102C, 102D may be positioned adjacent one another, and/or coupled to one another via brackets 146, 148, 150. More specifically, support structures 104A, 104B, 104C, 104D and/or base frames 106A, 106B, 106C, 106D of each of the plurality of portable PV assemblies 102A, 102B, 102C, 102D may be coupled to one another via brackets 146, 148, 150. In the non-limiting examples shown in FIGS. 14-16, second side 118A of base frame 106A for portable PV assembly 102A may be coupled to first side 112B of base frame 106B for portable PV assembly 102B via bracket 146. Additionally, second side 118B of base frame 106B for portable PV assembly 102B may be coupled to first side 112C of base frame 106C for portable PV assembly 102C via bracket 148. Finally in the non-limiting example, second side 118C of base frame 106C for portable PV assembly 102C may be coupled to first side 112D of base frame 106D for portable PV assembly 102D via bracket 150. As discussed herein, coupling the plurality of portable PV assemblies 102A, 102B, 102C, 102D using brackets 146, 148, 150 may aid in the rapid installation of the plurality of portable PV assemblies 102A, 102B, 102C, 102D to form solar energy system 100.

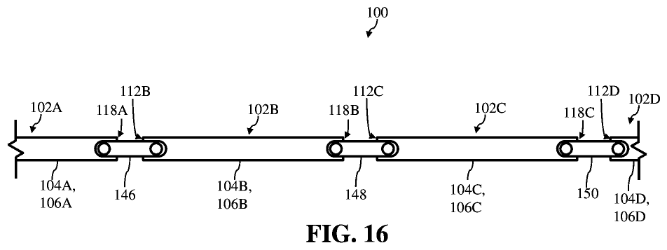

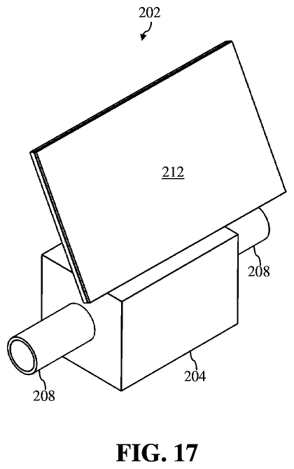

A process of unfolding and/or installing the plurality of portable PV assemblies 102A, 102B, 102C, 102D to form solar energy system 100 (see, FIG. 13) may now be discussed with reference to FIGS. 14-16. FIG. 14 shows the plurality of portable PV assemblies 102A, 102B, 102C, 102D in a collapsed state and/or in a position or orientation that would be similar to when the plurality of portable PV assemblies 102A, 102B, 102C, 102D are stored in storage container 142 (see, FIG. 12). When the plurality of portable PV assemblies 102A, 102B, 102C, 102D are removed from storage container 142 they may be unfolded to and/or installed in an operational state or position. For example, and with reference to FIGS. 15 and 16, the plurality of portable PV assemblies 102A, 102B, 102C, 102D may be removed from the storage container 142 and unfolded in an accordion-style such that the substantially vertical and/or upright portable PV assemblies 102A, 102B, 102C, 102D (see, FIG. 14) may stretch, span, and/or be positioned in a substantially horizontal position or orientation (e.g., operational state or position) (see, FIG. 16). The accordion-style folding/unfolding of the plurality of portable PV assemblies 102A, 102B, 102C, 102D may be achieved as a result of how each of the plurality of portable PV assemblies 102A, 102B, 102C, 102D are coupled together using brackets 146, 148, 150 (e.g., second side 118A to first side 112B via bracket 146, second side 118B to first side 112C via bracket 148, and so on). Additionally, and to aid in the ability to unfold in an accordion-style and rapidly install the plurality of portable PV assemblies 102A, 102B, 102C, 102D, brackets 146, 148, 150 coupling the plurality of portable PV assemblies 102A, 102B, 102C, 102D may allow each of the plurality of portable PV assemblies 102A, 102B, 102C, 102D to rotate and/or pivot about its respective sides.

Then number of portable PV assemblies 102A, 102B, 102C, 102D shown in FIGS. 14-16 to form solar energy system 100 is merely illustrative. As such, it is understood that solar energy system 100 may include more or less portable PV assemblies 102A, 102B, 102C, 102D to form solar energy system 100.

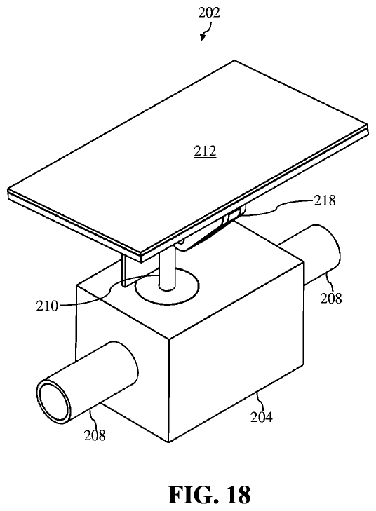

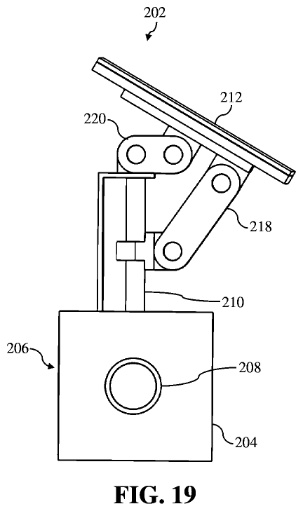

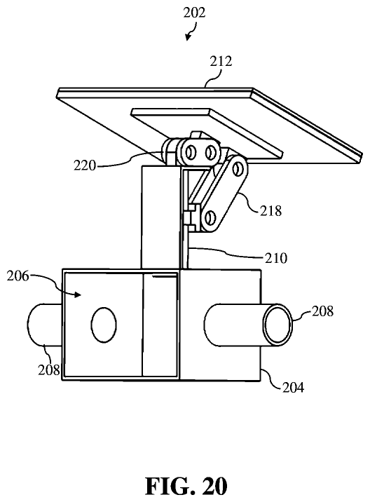

FIGS. 17-20 show various views of an additional, non-limiting example of components that may form solar energy system 200. More specifically, FIGS. 17-20 show various views of a heliostat component 202 that may form solar energy system 200. FIG. 17 shows a front isometric view of heliostat component 202 in a first position, FIG. 18 shows a front isometric view of heliostat component 202 in a second position, FIG. 19 shows a side view of heliostat component 202 in a third position, and FIG. 20 shows a back isometric view of heliostat component 202 in the third position.

As shown in FIGS. 17-20, heliostat component 202 may include a base 204. Base 204 may include a substantially rigid structure that may support the various components of heliostat component 202. For example, base 204 may be a substantially rigid box or container. Additionally, base 204 may be substantially hollow and/or may include an internal cavity 206, as shown in FIG. 20. Internal cavity 206 may house and/or contain various features of heliostat component 202 including, but not limited to, wiring (not shown) for heliostat component 202 and/or a motor (not shown) for controlling the movement of various features of heliostat component 202.

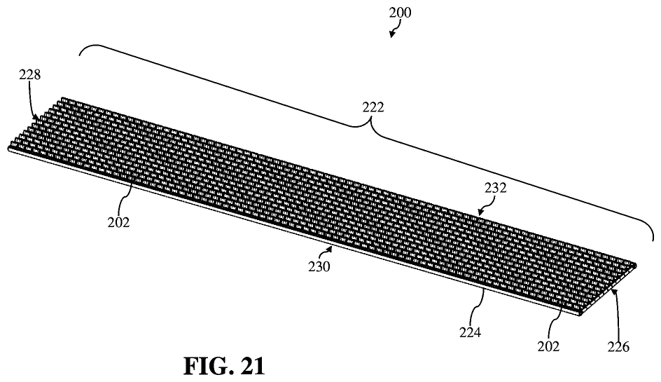

Additionally as shown in FIGS. 17-20, heliostat component 202 may also include a plurality of connectors 208. Connectors 208 may extend from base 204. More specifically, connectors 208 may extend from opposite sides of base 204 of heliostat component 202. In the non-limiting example, the connectors 208 may extend on either side of internal cavity 206 formed in base 204. As shown in FIGS. 17-20, connectors 208 may be substantially hollow, and may be in communication with internal cavity 206. As a result of being hollow and in communication with internal cavity 206 of base 204, features of heliostat component 202, such as wiring (not shown) may pass through connectors 208 of heliostat component 202. In the non-limiting example, the wiring passing through connector 208 may be connected to and/or place heliostat component 202 shown in FIGS. 17-20 in electronic communication with adjacent heliostat component of solar energy system 200 (see, FIGS. 21-23).

In the non-limiting example, heliostat component 202 may also include a post 210. Post 210 may extend from base 204 of heliostat component 202. More specifically, and as shown in FIGS. 18-20 post 210 may extend substantially perpendicular from base 204 of heliostat component 202. Additionally, post 210 may extend substantially perpendicular to connectors 208. Post 210 may provide structure and/or support to additional components and/or features of heliostat component 202, as discussed herein.

Heliostat component 202 of solar energy system 200 (see, FIGS. 21-23) may also include a mirror 212. Mirror 212 may be coupled to, supported by, and/or positioned on post 210. Additionally, mirror 212 of heliostat component 202 may be pivotably coupled to post 210. That is, and as shown in the non-limiting example of FIGS. 18-20 mirror 212 may be pivotably coupled to post 210 via hinges 218, 220. Hinges 218, 220 may be configured to move, adjust, and/or rotate, mirror 212 about post 210. Utilizing hinges 218, 220, mirror 212 may move about post 210 using a motor or drive mechanism (not shown). Mirror 212 may be any suitable component including reflective properties for reflecting sunlight toward a predetermined target (not shown) of solar energy system 200 to generate power and/or energy. Mirror's 212 ability to move, adjust, and/or rotate about post 210 using hinges 218, 220 may allow mirror 212 to move or adjust with the position of the sun through the day.

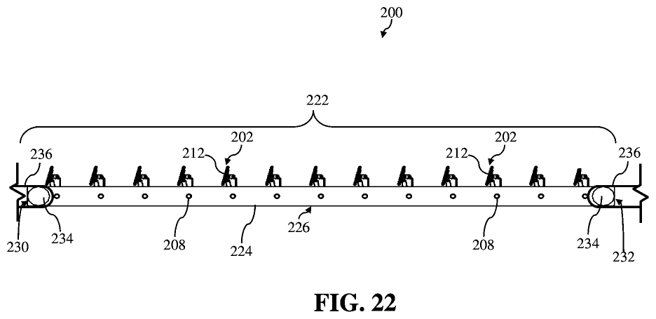

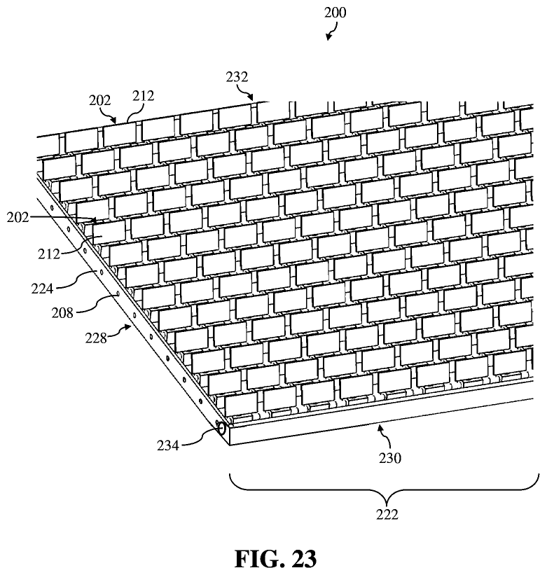

FIGS. 21-23 various views of a single portable heliostat assembly 222 forming solar energy system 200. Specifically, FIG. 21 shows an isometric view of solar energy system 200 formed from a single portable heliostat assembly 222 including a plurality of heliostat components 202, FIG. 22 shows a side view of the single portable heliostat assembly 222 forming solar energy system 200, and FIG. 23 shows an isometric view of a detailed portion of the single portable heliostat assembly 222 forming solar energy system 200.

As shown in FIGS. 21-23, the single portable heliostat assembly 222 may be formed from a plurality of heliostat components 202. Specifically, the single portable heliostat assembly 222 of solar energy system 200 may be formed from a plurality of heliostat components 202 arranged in rows/columns and substantially coupled together. As discussed herein, connectors 208 of each heliostat component 202 (see, FIGS. 17-20) may be coupled to adjacent heliostat components 202 within the single portable heliostat assembly 222.

Additionally, and as shown in FIGS. 21-23 the heliostat components 202 positioned on the boundaries and/or outer edges of the single portable heliostat assembly 222 may also be coupled to a support structure 224 via connectors 208. That is, the single portable heliostat assembly 222 of FIGS. 21-23 may also include support structure 224 for holding, including, and/or providing a rigid structure for the plurality of heliostat components 202 of the single portable heliostat assembly 222. In the non-limiting example, support structure 224 may be formed from I-beams of, e.g., steel, or other metal segments joined, coupled, or welded together. However, it is understood support structure 224 may be formed as any component or structure that may support the various components of portable heliostat assembly 222, and allow solar energy system 200 to be rapidly installed, as discussed herein.

Support structure 224 may include a first end 226, and a second end 228 positioned opposite the first end 226. Additionally, support structure 224 may also include a first side 230 extending between first end 226 and second end 228, and a second side 232 extending between first end 226 and second end 228. Second side 232 may also extend and/or may be positioned opposite first side 230 of support structure 224. As shown in FIGS. 21-23, the various ends 226, 228, and sides 230, 232 may be configured such that support structure 224 is substantially quadrilateral (e.g., rectangular).

As shown in the non-limiting example of FIGS. 22 and 23, the heliostat components 202 positioned on the boundaries and/or outer edges of the single portable heliostat assembly 222 may also be coupled to support structure 224 via connectors 208. Connectors 208 of the boundary heliostat components 202 forming the portable heliostat assembly 222 may be coupled directly to one of first end 226 or second end 228. Additionally, and because each of the plurality of heliostat components 202 forming the portable heliostat assembly 222 are coupled together via connectors 208, connectors 208 of the boundary heliostat components 202 coupled directly to one of first end 226 or second end 228 may couple and/or secure the plurality of heliostat components 202 to or within support structure 224 to form solar energy system 200.

Turning to FIG. 22, support structure 224 may also include a plurality of pins 234 positioned on first end 226 and second end 228 (not shown). Specifically, support structure 224 may include pins 234 positioned on first end 226 directly adjacent first side 230 and second side 232, respectively, and pins 234 positioned on second end 228 (not shown) directly adjacent first side 230 and second side 232, respectively. Pins 234 may be formed on support structure 224 to receive coupling brackets 236. Coupling brackets 236 may be substantially similar to brackets 146, 148, 150 discussed herein with respect to FIGS. 14-16. As such, the inclusion of pins 234 and brackets 236 within support structure 224 of solar energy system 200 may allow for a plurality portable heliostat assemblies 222 to be coupled together and rapidly installed for operation. That is, and as discussed herein, solar energy system 200 may include a plurality portable heliostat assemblies 222 that may be coupled together, may be stored in a storage container (e.g., storage container 143: FIG. 12) in a collapsed state, and rapidly installed from the storage container by unfolding the plurality portable heliostat assemblies 222 in an accordion-style as a result of brackets 236. Redundant explanation of the accordion-style unfolding process and/or rapid installation of a plurality portable heliostat assemblies 222 forming solar energy system 200 has been omitted for clarity.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An solar energy system comprising:
a plurality of portable photovoltaic (PV) assemblies coupled together, each of the plurality of PV assemblies including:
a support structure including:
a base frame including:
a first end;
a second end positioned opposite the first end;
a first side extending between the first end and the second end;
a second side extending between the first end and the second end, the second side positioned opposite the first side; and
at least one stiffener extend between the first side and the second side;
a first plurality of supports positioned adjacent the first side of the base frame, each of the first plurality of supports including:
a first end pivotably coupled to the base frame; and
a second end positioned opposite the first end; and
a second plurality of supports positioned adjacent the second side of the base frame, each of the second plurality of supports including:
a first end pivotably coupled to the base frame; and
a second end positioned opposite the first end;
a first plurality of photovoltaic (PV) components pivotably coupled to the second end of the first plurality of supports; and
a second plurality of PV components pivotably coupled to the second end of the second plurality of supports.

2. An solar energy system comprising:
a plurality of portable heliostat assemblies coupled together, each of the plurality of heliostat assemblies including:
a support structure including:
a first end;
a second end positioned opposite the first end;
a first side extending between the first end and the second end; and
a second side extending between the first end and the second end, the second side positioned opposite the first side; and
a plurality of heliostat components extending between the first end and the second end of the support structure, each of the plurality of heliostat components including:
a base;
a plurality of connector extending from the base, each connector for connecting the base to one of a first end of the support structure, a second end of the support structure, or a distinct base of a distinct;
a post extending from the base; and
a mirror pivotably coupled to the post.
